(19) United States
(12) Patent Application Publication
(10) Pub. No.: US 2026/0091449 A1
(43) Pub. Date: Apr. 2, 2026

(54) LASER WELDING DEVICE AND LASER WELDING METHOD USING THE SAME

(71) Applicant: SK ON CO., LTD., Seoul (KR)

(72) Inventor: Taek Eon JEONG, Daejeon (KR)

(21) Appl. No.: 19/313,741

(22) Filed: Aug. 28, 2025

(30) Foreign Application Priority Data
Sep. 27, 2024 (KR) 10-2024-0131806

(51) Int. Cl. B23K 26/22; H01M 50/528; H01M 50/566

(52) U.S. Cl. CPC B23K 26/22; H01M 50/528; H01M 50/566

(57) ABSTRACT

The laser welding device according to exemplary embodiments of the present disclosure includes: a laser irradiation unit configured to emit a welding laser beam; an upper mask disposed between the laser irradiation unit and welding targets, namely, an electrode tab part and an electrode lead; and a lower mask disposed below the welding targets, wherein the upper mask includes through-holes, and the laser beam is irradiated onto the welding targets through the through-holes, and at least one of the upper mask and the lower mask moves toward the welding targets to apply pressure to the welding targets.

### CROSS-REFERENCES TO RELATED APPLICATION

The present application claims priority under 35 U.S.C. § 119(a) to Korean Patent Application Number 10-2024-0131806, filed on September 27, 2024, which is incorporated herein by reference in its entirety.

### BACKGROUND

### 1. Field of the Invention

The present disclosure relates to a laser welding device and a laser welding method using the same.

### 2. Description of the Related Art

Secondary batteries are batteries that can be repeatedly charged and discharged. With the development of information and communication and display industries, they have been widely applied as power sources for portable electronic communication devices, such as camcorders, mobile phones, and laptop PCs. In addition, battery packs including secondary batteries have recently been developed and applied as power sources for eco-friendly vehicles, such as electric cars.

Examples of secondary batteries include lithium secondary batteries, nickel-cadmium batteries, and nickel-hydrogen batteries. Among these, research and development are currently underway to increase the energy density per unit weight of lithium secondary batteries.

To increase the energy density of secondary batteries, the number of stacked cells must be increased. However, in this case, applying conventional ultrasonic welding methods may degrade the weld quality.

### SUMMARY

An object of the present disclosure is to provide a laser welding device capable of reducing the defect rate in welding an electrode tab part and a lead.

Another object of the present disclosure is to provide a laser welding method using the laser welding device.

A laser welding device according to exemplary embodiments of the present disclosure includes: a laser irradiation unit configured to emit a welding laser beam; an upper mask disposed between the laser irradiation unit and welding targets, namely, an electrode tab part and an electrode lead; and a lower mask disposed below the welding targets. The upper mask includes through-holes, and the laser beam is irradiated onto the welding targets through the through-holes, and at least one of the upper mask and the lower mask moves toward the welding targets to apply pressure to the welding targets.

In exemplary embodiments, the through-holes of the upper mask may be formed in a predetermined pattern, and the lower mask may include a through-hole pattern identical to that of the upper mask.

In exemplary embodiments, the through-holes of the upper mask may be formed in a predetermined pattern, and the lower mask may include a through-hole pattern different from that of the upper mask.

In exemplary embodiments, a horizontal sectional shape of the through-hole in the lower mask may differ from that of the through-hole in the upper mask.

In exemplary embodiments, a horizontal sectional area of the through-hole in the lower mask may differ from that of the through-hole in the upper mask.

In exemplary embodiments, the lower mask may not include through-holes.

In exemplary embodiments, the lower mask may include a groove in a laser irradiation region on a surface facing the upper mask.

In exemplary embodiments, the lower mask may further include a pressurizing device in a laser irradiation region on a surface facing the upper mask.

In exemplary embodiments, the pressurizing device may include at least one selected from the group consisting of a spring, a cylinder and a servo cylinder.

In a laser welding method according to exemplary embodiments of the present disclosure, one end of an electrode tab part and one end of an electrode lead are aligned to overlap each other. An upper mask and a lower mask, disposed above and below an overlapping region between one end of the electrode tab part and one end of the electrode lead, apply pressure to the overlapping region. The upper mask includes through-holes, and the overlapping region is irradiated with a laser beam through the through-holes.

In exemplary embodiments, the through-holes of the upper mask may be formed in a predetermined pattern, and the lower mask may include a through-hole pattern identical to that of the upper mask.

In exemplary embodiments, the through-holes of the upper mask may be formed in a predetermined pattern, and the lower mask may include a through-hole pattern different from that of the upper mask.

In exemplary embodiments, a horizontal sectional shape of the through-hole in the lower mask may differ from that of the through-hole in the upper mask.

In exemplary embodiments, a horizontal sectional area of the through-hole in the lower mask may differ from that of the through-hole in the upper mask.

In exemplary embodiments, the lower mask may not include through-holes.

In exemplary embodiments, the lower mask may include a groove in a laser irradiation region on a surface facing the upper mask.

In exemplary embodiments, the lower mask may further include a pressurizing device in a laser irradiation region on a surface facing the upper mask.

In exemplary embodiments, the pressurizing device may include at least one selected from the group consisting of a spring, a cylinder and a servo cylinder.

In exemplary embodiments, the method may not include a pre-welding step.

A lithium secondary battery according to exemplary embodiments of the present disclosure includes electrode tabs and electrode leads welded using the above-described laser welding method.

The laser welding method using the laser welding device according to exemplary embodiments of the present disclosure may reduce the welding defect rate and processing time, and thus may contribute to a reduction in production costs.

The secondary battery manufactured using the laser welding method of the present disclosure may be widely applied in green technology fields, such as electric vehicles, battery charging stations, solar power generation, wind power generation, and the like, which use the batteries. Further, the lithium secondary battery manufactured using the laser welding method of the present disclosure may be used in eco-friendly electric vehicles, hybrid vehicles, and the like, which are aimed at mitigating climate change by reducing air pollution and greenhouse gas emissions.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a schematic diagram illustrating a laser welding device, an electrode tab part, and an electrode lead according to exemplary embodiments;

FIG. 2 is a schematic flowchart for describing processes of a laser welding method according to exemplary embodiments;

FIG. 3 is a schematic horizontal sectional view of an upper mask according to exemplary embodiments;

FIGS. 4 and 5 are schematic horizontal sectional views of a lower mask according to exemplary embodiments;

FIG. 6 is a schematic vertical sectional view of the lower mask including the upper mask and a pressurizing device according to exemplary embodiments;

FIG. 7 is a schematic diagram illustrating an arrangement of the electrode tab part, the electrode lead, and the mask during a laser irradiation step according to exemplary embodiments; and

FIGS. 8 and 9 are a plan view and a cross-sectional view, respectively, illustrating a secondary battery according to exemplary embodiments.

### DETAILED DESCRIPTION OF THE INVENTION

According to exemplary embodiments of the present disclosure, a laser welding device and a laser welding method for welding an electrode tab part and an electrode lead using a laser are provided.

The exemplary embodiments will now be described in more detail with reference to the accompanying drawings. However, the drawings and embodiments included in the present specification are merely intended to facilitate understanding of the technical concept of the present disclosure. Accordingly, the present disclosure should not be construed as being limited only to the matters described in the drawings and embodiments.

The terms “upper portion,” “lower portion,” “upper surface,” “lower surface,” and the like as used herein do not refer to absolute positions, but are used in a relative sense. For example, such terms are used to distinguish areas with respect to a particular reference surface.

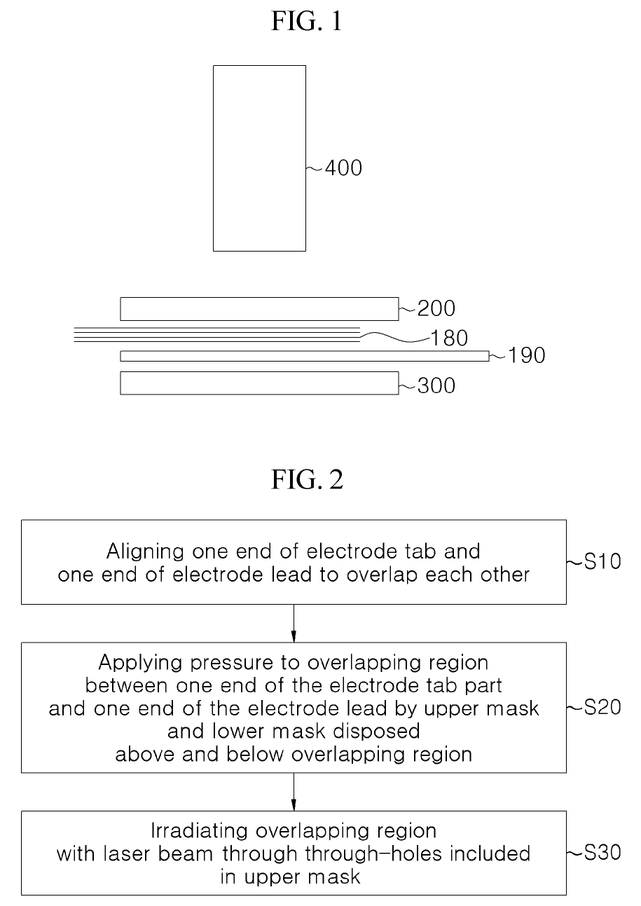

FIG. 1 is a schematic diagram illustrating a laser welding device, an electrode tab part, and an electrode lead according to exemplary embodiments.

Referring to FIG. 1, the laser welding device includes a laser irradiation unit 400, an upper mask 200, and a lower mask 300.

The laser irradiation unit 400 emits a welding laser beam. The type of the welding laser is not particularly limited as long as it can be used to weld the electrode tab part and the electrode lead, and may be, for example, an IR laser or a green laser.

The upper mask 200 is disposed between the laser irradiation unit 400 and the welding targets, namely, an electrode tab part 180 and an electrode lead 190.

The upper mask 200 includes through-holes described below, and a laser beam is irradiated onto the welding targets through the through-holes.

The lower mask 300 is disposed below the welding targets.

In the laser welding device according to exemplary embodiments of the present disclosure, at least one of the upper mask 200 and the lower mask 300 moves toward the welding targets to apply pressure to them.

FIG. 2 is a schematic flowchart for describing processes of a laser welding method according to exemplary embodiments. Hereinafter, the laser welding method will now be described with reference to FIG. 2.

Referring to FIG. 2, in the laser welding method, one end of an electrode tab part and one end of an electrode lead are aligned to overlap each other (S10).

The electrode tab part includes a plurality of electrode tabs, and the electrode tabs may be cathode tabs or anode tabs. The electrode lead aligned to overlap with the cathode tab part, which includes the cathode tabs, may be a cathode lead, and the electrode lead aligned to overlap with the anode tab part, which includes the anode tabs, may be an anode lead.

The electrode tab may be a member formed by extending one end of a current collector and may be a portion electrically connected to the electrode lead, thereby transferring the flow of charge generated in the current collector to the electrode lead.

The electrode lead may be a member that is electrically connected to tabs of the same polarity and is configured to transfer the flow of charge generated in the current collector to the outside of the battery. For example, the electrode lead may be made of aluminum, nickel, copper, or the like.

In exemplary embodiments, an upper mask and a lower mask, respectively disposed above and below an overlapping region between one end of the electrode tab part and one end of the electrode lead, apply pressure to the overlapping region (S20).

As the upper mask and the lower mask apply pressure to the overlapping region, the spacing between the plurality of electrode tabs positioned in the overlapping region may decrease. Consequently, when laser irradiation is performed in S30 described below, the welding heat input required for welding may be reduced. As a result, the welding defect rate, such as disconnection of electrode tabs due to excessive heat input applied to the overlapping region during the welding process, may be reduced. Accordingly, an increase in resistive heating at the tab part of the secondary battery may be prevented, and the risk of short-circuiting and fire caused by short-circuiting of the electrode tabs may be reduced.

In some embodiments, the upper mask and the lower mask may be disposed to face each other above and below one end of the overlapped electrode tab part and one end of the electrode lead. Subsequently, the upper and lower masks may move toward one end of the overlapped electrode tab part and one end of the electrode lead, respectively, thereby applying pressure to the region where one end of the electrode tab part overlaps with one end of the electrode lead.

In some embodiments, to effectively apply pressure to the overlapping region, the upper and lower masks may have a larger area than the overlapping region.

According to exemplary embodiments, the electrode lead may be disposed below the electrode tab part in the overlapping region, and the laser beam may be irradiated toward the electrode tab part. If the electrode lead is positioned above the electrode tab part, welding the electrode lead and the electrode tab part in the overlapping region requires penetrating the relatively thick electrode lead. Accordingly, the heat input required for welding may increase compared to the case where the electrode lead is positioned below the electrode tab part, thereby increasing the welding defect rate, such as disconnection of the electrode tabs during the welding process. As a result, when the electrode tab part is positioned above the electrode lead, the safety of the secondary battery may be improved, such as by reducing the risk of fire.

In exemplary embodiments, the upper mask includes through-holes, and a laser beam is irradiated onto the overlapping region through the through-holes (S30).

When the laser beam is irradiated onto the overlapping region through the through-holes of the upper mask, a laser irradiation region may be formed on the upper surface of the overlapping region. The welding heat input of the laser beam may be transmitted to the laser irradiation region, thereby welding the electrode tab part and the electrode lead.

The laser welding method according to exemplary embodiments may be a partial penetration welding method. Accordingly, the welding heat input transmitted to the laser irradiation region may be reduced, thereby decreasing the welding defect rate.

In some embodiments, the lower mask may be a solid type that does not include through-holes. If the lower mask is a solid type, the pressure applied to the laser irradiation region of the electrode tab part and the electrode lead may increase during partial penetration welding. Consequently, the risk of electrode tabs being disconnected may be reduced, thereby reducing the risk of short-circuiting and fire in the secondary battery.

The type of laser is not particularly limited as long as it can be used for welding the electrode tab part and the electrode lead, and may be, for example, an IR laser, a green laser, or the like.

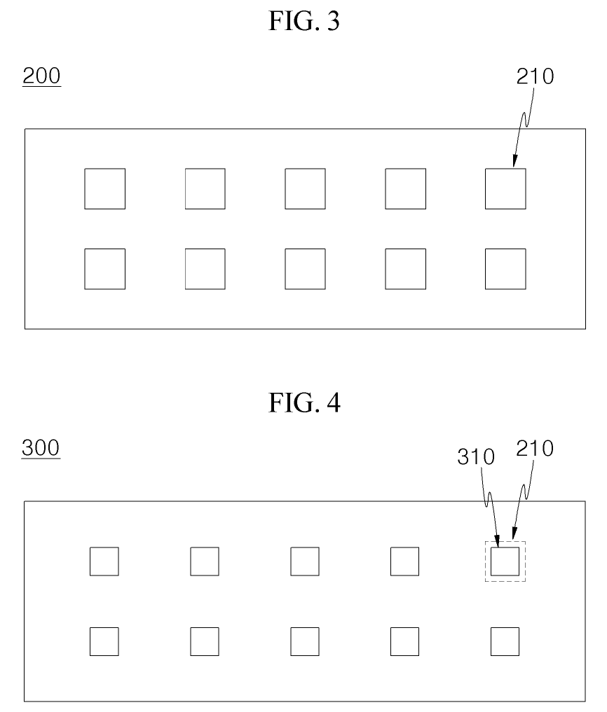

FIG. 3 is a schematic horizontal sectional view of the upper mask according to exemplary embodiments.

As used herein, the term “horizontal section” refers to a cross-section cut in a direction perpendicular to the laser irradiation direction.

As used herein, the term “vertical section” refers to a cross-section cut in a direction parallel to the laser irradiation direction.

Referring to FIG. 3, through-holes 210 of the upper mask 200 may be formed in a predetermined pattern. For example, a plurality of the through-holes 210 may be arranged along a predetermined line in the upper mask 200, and a plurality of such lines may be arranged at predetermined intervals.

For convenience of illustration, in FIG. 3, the horizontal section of the through-holes 210 is depicted as a square, but the shape of the through-holes 210 may be a circle, a polygon, or the like, and is not limited thereto.

In exemplary embodiments, the sizes of the through-holes 210 of the upper mask 200 may all be uniform.

For example, when the through-holes 210 are circular, the diameter of the through-holes 210 may be 0.1 mm to 10 mm, 0.3 mm to 7 mm, or 0.5 mm to 5 mm.

For example, when the through-holes 210 are square, the length of one side of the through-holes 210 may be 0.1 mm to 10 mm, 0.3 mm to 7 mm, or 0.5 mm to 5 mm.

In exemplary embodiments, the spacing between adjacent through-holes 210 in the upper mask 200 may be greater than 0 and less than or equal to 20 mm, greater than 0 and less than or equal to 15 mm, or greater than 0 and less than or equal to 10 mm.

By adjusting the shape, size, or spacing of the through-holes 210, the position of the laser irradiation region, welding heat input, and the like may be controlled. Accordingly, the welding defect rate, such as disconnection that may occur when irradiating with the laser beam, may be reduced.

In exemplary embodiments, the through-hole pattern of the lower mask 300 may be identical to the through-hole pattern of the upper mask 200.

In exemplary embodiments, the through-hole pattern of the lower mask 300 may differ from the through-hole pattern of the upper mask 200.

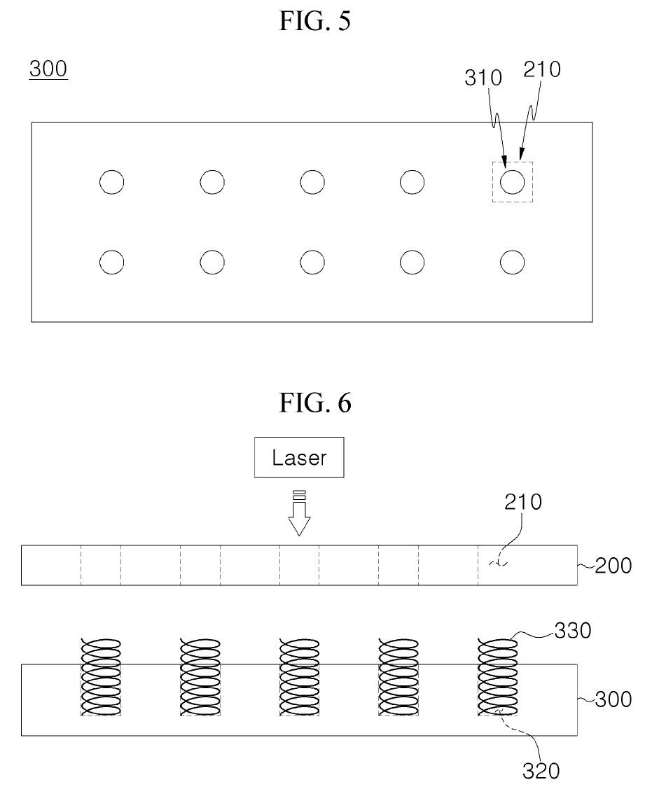

FIGS. 4 and 5 are schematic horizontal sectional views of the lower mask according to exemplary embodiments, respectively.

Referring to FIGS. 4 and 5, the through-holes 310 of the lower mask 300 may be formed in a predetermined pattern.

Referring to FIG. 4, the horizontal sectional shape of the through-holes of the lower mask 300 may be identical to the horizontal sectional shape of the through-holes of the upper mask 200.

Referring to FIG. 5, the horizontal sectional shape of the through-holes of the lower mask 300 may differ from that of the through-holes of the upper mask 200.

In exemplary embodiments, the horizontal sectional area of the through-hole 310 of the lower mask 300 may differ from that of the through-hole 210 of the upper mask 200. Referring to FIGS. 4 and 5, the horizontal sectional area of the through-hole 310 of the lower mask 300 may be smaller than the horizontal sectional area of the through-hole 210 of the upper mask 200. Alternatively, the horizontal sectional shape of the through-hole of the lower mask 300 may differ from that of the through-hole of the upper mask 200. As a result, the pressurizing area of the laser irradiation region by the masks may increase, thereby reducing the welding defect rate.

In some embodiments, centerlines passing through the centers of the through-holes 210 of the upper mask 200 may pass through the centers of the through-holes 310 of the lower mask 300. Accordingly, laser welding using a full penetration welding method is also possible, and welding between the lower mask 300 and the electrode lead may be prevented.

In exemplary embodiments, the lower mask 300 may not include through-holes. If the lower mask 300 is a solid type that does not include through-holes, the pressurizing area of the lower mask on the overlapping region may increase, thereby reducing the welding defect rate.

In exemplary embodiments, the lower mask 300 may include a groove in the laser irradiation region of the surface facing the upper mask 200.

In exemplary embodiments, the horizontal sectional area of the groove of the lower mask 300 may differ from that of the through-hole 210 of the upper mask 200. For example, the horizontal sectional area of the groove of the lower mask 300 may be smaller than the horizontal sectional area of the through-hole 210 of the upper mask 200. Alternatively, the horizontal sectional shape of the groove of the lower mask 300 may differ from that of the through-hole of the upper mask 200. Accordingly, the pressurizing area of the laser irradiation region by the masks may increase, thereby reducing the welding defect rate.

In exemplary embodiments, the lower mask 300 may further include a pressurizing device 330 in the laser irradiation region of the surface facing the upper mask 200.

FIG. 6 is a schematic vertical sectional view of the lower mask including the upper mask and the pressurizing device according to exemplary embodiments.

Referring to FIG. 6, when irradiated with a laser beam, the laser irradiation region may be pressurized via the pressurizing device 330, thereby reducing the spacing between the electrode tabs. Consequently, the welding defect rate may be reduced.

In exemplary embodiments, the pressurizing device may include at least one selected from the group consisting of a spring, a cylinder, a servo cylinder, and the like.

For example, the pressurizing device may be disposed inside the groove 320 of the lower mask 300.

The laser welding method according to exemplary embodiments may not include a pre-welding step. Since the welding method of the present disclosure according to exemplary embodiments may reduce the spacing between the electrode tabs by pressurizing the masks in step S20, the welding defect rate may not increase even if the pre-welding step is omitted and laser welding is performed.

For example, the pre-welding may include ultrasonic welding. To increase the energy density of a secondary battery, the number of stacked cathodes and anodes in the electrode assembly must be increased, thereby increasing the required welding energy. In this case, performing ultrasonic welding prior to laser welding may increase the incidence of defects such as seizing or tearing of the electrode tabs. Additionally, if the electrode tabs are seized, the welding process must be halted for regrinding or replacement of the anvil, which may result in a decrease in the production yield of the secondary battery.

The welding method of the present disclosure, according to exemplary embodiments, does not include a pre-welding step, thereby reducing defects associated with ultrasonic welding and lowering production costs incurred by its implementation.

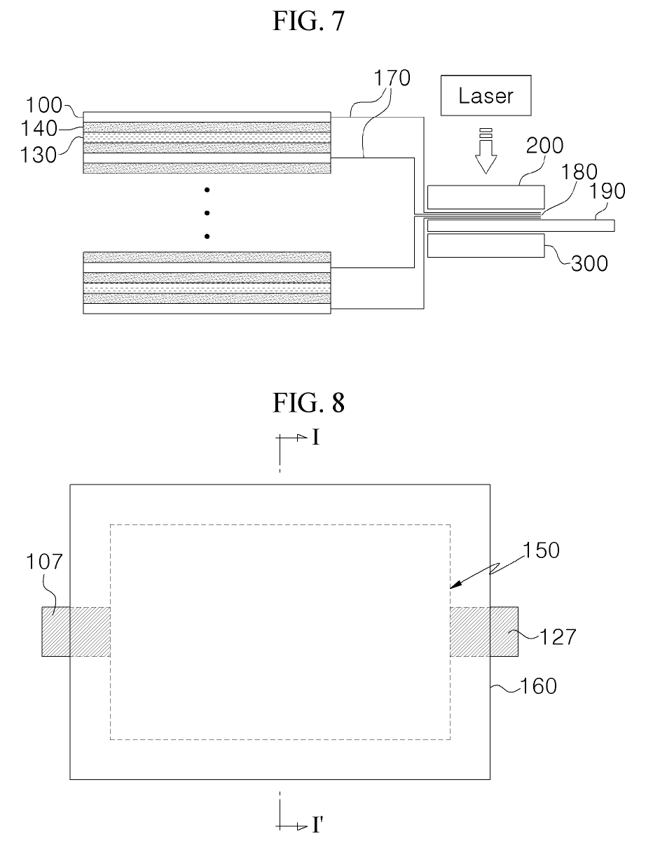

FIG. 7 is a schematic diagram illustrating an arrangement of the electrode tab part, the electrode lead, and the mask in a laser irradiation step according to exemplary embodiments.

Referring to FIG. 7, the electrode tab part 180 may include a plurality of electrode tabs 170 extending from one end of an electrode assembly 150.

The electrode assembly 150 may include repeatedly stacked electrodes and a separation membrane 140 disposed between the electrodes. Each of the electrodes may include an active material layer formed on an electrode current collector.

The electrodes may include a cathode 100 and an anode 130. The electrode current collector may include a cathode current collector 105 included in the cathode 100 and an anode current collector 125 included in the anode 130. The active material layer may include a cathode active material layer 110 included in the cathode 100 and an anode active material layer 120 included in the anode 130.

The cathode 100 may include the cathode current collector 105 and the cathode active material layer 110 formed by applying a cathode active material to the cathode current collector 105. The cathode active material may include a compound capable of reversibly intercalating and deintercalating lithium ions. In this case, the secondary battery may be provided as a lithium secondary battery.

In exemplary embodiments, the cathode active material may include lithium-transition metal composite oxide particles. For example, the lithium-transition metal composite oxide particles may include nickel (Ni), and may further include at least one of cobalt (Co) and manganese (Mn).

For example, the cathode current collector 105 may include stainless steel, nickel, aluminum, titanium, copper, zinc, or an alloy thereof, and preferably includes aluminum or an aluminum alloy.

For example, the cathode active material may be mixed and stirred with a binder, a conductive agent, and/or a dispersing agent in a solvent to prepare a slurry. The slurry may be coated on the cathode current collector 105, then dried and compressed to prepare the cathode 100 including the cathode active material layer 110.

The binder may include, for example, an organic binder such as vinylidene fluoride-hexafluoropropylene copolymer (PVDF-co-HFP), polyvinylidene fluoride (PVDF), polyacrylonitrile, polymethyl methacrylate, etc., or an aqueous binder such as styrene-butadiene rubber (SBR), and may be used together with a thickener such as carboxymethyl cellulose (CMC).

For example, a PVDF-based binder may be used as the cathode binder. In this case, an amount of the binder for forming the cathode active material layer may be reduced and an amount of the cathode active material may be relatively increased, thereby improving the output and capacity of the secondary battery.

The conductive material may be included to promote electron migration between the active material particles. For example, the conductive material may include carbon-based conductive materials such as graphite, carbon black, graphene, or carbon nanotubes and/or metal-based conductive materials, including perovskite materials, such as tin, tin oxide, titanium oxide, LaSrCoO₃, and LaSrMnO₃, etc.

The anode 130 may include the anode current collector 125 and the anode active material layer 120 formed by coating the anode active material onto the anode current collector 125.

As the anode active material, any active material known in the art may be used, so long as it is capable of intercalating and deintercalating lithium ions. For example, carbon-based materials such as crystalline carbon, amorphous carbon, carbon composite, carbon fibers, etc., a lithium alloy, or a silicon (Si)-based active material may be used. Examples of the amorphous carbon may include hard carbon, coke, mesocarbon microbeads (MCMB), mesophase pitch-based carbon fibers (MPCF), or the like.

Examples of the crystalline carbon may include graphite-based carbon such as natural graphite, artificial graphite, graphitized coke, graphitized MCMB, graphitized MPCF or the like. Elements included in the lithium alloy may include aluminum, zinc, bismuth, cadmium, antimony, silicon, lead, tin, gallium or indium or the like.

The anode current collector 125 may include stainless steel, copper, nickel, aluminum, titanium, or an alloy thereof. Preferably, the anode current collector 125 includes copper or a copper alloy.

For example, a form of slurry may be prepared by mixing the anode active material with the above-described binder, conductive material, thickener, and the like in a solvent, followed by stirring the same. The slurry may be coated on at least one surface of the anode current collector 125, and then dried and compressed to prepare the anode 130 including the anode active material layer 120.

As the binder and the conductive material, materials which are substantially the same as or similar to the above-described materials used in the cathode active material layer 110 may be used. In some embodiments, a binder for forming an anode may include, for example, an aqueous binder such as styrene-butadiene rubber (SBR) to ensure compatibility with a carbon-based active material, and may be used together with a thickener such as carboxymethyl cellulose (CMC).

The separation membrane 140 may be interposed between the cathode 100 and the anode 130. The separation membrane 140 may include a porous polymer film made of a polyolefin polymer such as ethylene homopolymer, propylene homopolymer, ethylene/butene copolymer, ethylene/hexene copolymer, ethylene/methacrylate copolymer. The separation membrane 140 may include a nonwoven fabric made of glass fibers having a high melting point, polyethylene terephthalate fibers, etc.

According to exemplary embodiments, the cathode 100 and the anode 130 may be alternately and repeatedly stacked with the separation membrane 140 interposed therebetween, thereby defining the electrode assembly 150.

In exemplary embodiments, the upper mask 200 and the lower mask 300 may be positioned above and below, respectively, the region where one end of the electrode tab part 180 and one end of the electrode lead 190 overlap.

For convenience of illustration, the electrode assembly 150 is shown in FIG. 7 as a stacked type; however, the electrode assembly 150 may also have a jelly roll structure, for example, by winding or folding the separation membrane 140.

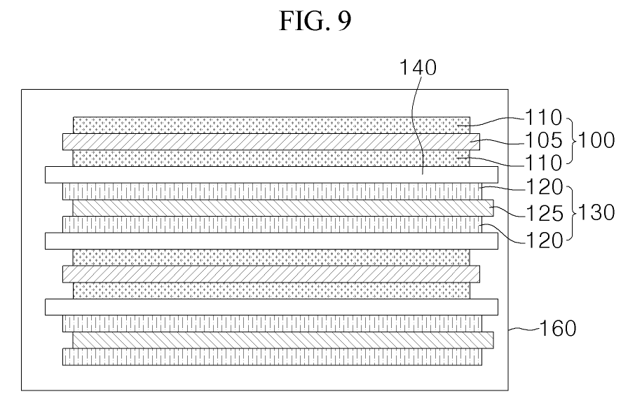

FIGS. 8 and 9 are a plan view and a cross-sectional view, respectively, illustrating a secondary battery according to exemplary embodiments. For example, FIG. 9 is a cross-sectional view taken along line I-I’ of FIG. 8 in the thickness direction.

The secondary battery shown in FIGS. 8 and 9 are schematically illustrated for convenience of description, and the structure of the secondary battery of the present disclosure is not limited to that shown in FIGS. 8 and 9.

According to exemplary embodiments, a unit cell is defined by the cathode 100, the anode 130 and the separation membrane 140, and a plurality of unit cells may be stacked to form, for example, the electrode assembly 150. The electrode assembly 150 may be a winding-type, a stacking-type, a z-folding-type, or a stacked-folding type.

The electrode assembly 150 may be accommodated in a case 160 together with an electrolyte to define a lithium secondary battery. According to exemplary embodiments, a non-aqueous electrolyte may be used as the electrolyte.

The non-aqueous electrolyte may include a lithium salt of an electrolyte and an organic solvent, the lithium salt is represented by, for example, Li⁺X⁻, and as an anion (X⁻) of the lithium salt, F⁻, Cl⁻, Br⁻, I⁻, NO₃⁻, N(CN)₂⁻, BF₄⁻, ClO₄⁻ , PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻_{,} CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻,SCN⁻ and (CF₃CF₂SO₂)₂N⁻, etc. may be exemplified.

As the organic solvent, for example, propylene carbonate (PC), ethylene carbonate (EC), diethyl carbonate (DEC), dimethyl carbonate (DMC), ethyl methyl carbonate (EMC), methyl propyl carbonate, dipropyl carbonate, dimethyl sulfoxide, acetonitrile, dimethoxyethane, diethoxyethane, vinylene carbonate, sulfolane, gamma-butyrolactone, propylene sulfite, or tetrahydrofuran may be used. These may be used alone or in combination of two or more thereof.

As shown in FIG. 8, electrode tabs (cathode tabs and anode tabs) may protrude from the cathode current collector 105 and the anode current collector 125, respectively, which belong to each electrode cell, and may extend to one side of the case 160. The electrode tabs may be fused together with the one side of the case 160 to form electrode leads (a cathode lead 107 and an anode lead 127) that extend or are exposed to the outside of the case 160.

Although FIG. 8 illustrates that the cathode lead 107 and the anode lead 127 protrude from both lateral sides of the case 160 in a planar direction, the positions of the electrode leads are not limited thereto. For example, the electrode leads may protrude from both sides of the case 160. Alternatively, the cathode lead 107 and the anode lead 127 may protrude from the same side of the case 160. For example, the cathode lead 107 and the anode lead 127 may be formed to protrude from the upper side, lower side, left side, or right side of the case 160.

The secondary battery may be manufactured, for example, in a cylindrical shape using a can, a prismatic shape, a pouch shape or a coin shape.

The lithium secondary battery according to exemplary embodiments of the present disclosure includes the electrode tabs and the electrode leads welded by the above-described laser welding method.

### Description of Reference Numerals

100: Cathode

105: Cathode current collector

107: Cathode lead

110: Cathode active material layer

120: Anode active material layer

125: Anode current collector

127: Anode lead

130: Anode

140: Separation membrane

150: Electrode assembly

160: Case

170: Electrode tab

180: Electrode tab part

190: Electrode lead

200: Upper mask

210, 310: Through-hole

300: Lower mask

320: Groove

330: Pressurizing device

400: Laser irradiation unit

1. A laser welding device comprising:
a laser irradiation unit configured to emit a welding laser beam;
an upper mask disposed between the laser irradiation unit and welding targets, namely, an electrode tab part and an electrode lead; and
a lower mask disposed below the welding targets,
wherein the upper mask comprises through-holes, and the laser beam is irradiated onto the welding targets through the through-holes, and
wherein at least one of the upper mask and the lower mask moves toward the welding targets to apply pressure to the welding targets.

2. The laser welding device according to claim 1, wherein the through-holes of the upper mask are formed in a predetermined pattern, and
the lower mask includes a through-hole pattern identical to that of the upper mask.

3. The laser welding device according to claim 1, wherein the through-holes of the upper mask are formed in a predetermined pattern, and
the lower mask includes a through-hole pattern different from that of the upper mask.

4. The laser welding device according to claim 3, wherein a horizontal sectional shape of the through-hole in the lower mask differs from that of the through-hole in the upper mask.

5. The laser welding device according to claim 3, wherein a horizontal sectional area of the through-hole in the lower mask differs from that of the through-hole in the upper mask.

6. The laser welding device according to claim 1, wherein the lower mask does not include through-holes.

7. The laser welding device according to claim 6, wherein the lower mask comprises a groove in a laser irradiation region on a surface facing the upper mask.

8. The laser welding device according to claim 1, wherein the lower mask further comprises a pressurizing device in a laser irradiation region on a surface facing the upper mask.

9. The laser welding device according to claim 8, wherein the pressurizing device comprises at least one selected from the group consisting of a spring, a cylinder and a servo cylinder.

10. A laser welding method comprising:
aligning one end of an electrode tab part and one end of an electrode lead to overlap each other;
applying pressure to an overlapping region between one end of the electrode tab part and one end of the electrode lead using an upper mask and a lower mask disposed above and below the overlapping region; and
irradiating the overlapping region with a laser beam through through-holes, wherein the through-holes are included in the upper mask.

11. The laser welding method according to claim 10, wherein the through-holes of the upper mask are formed in a predetermined pattern, and
the lower mask includes a through-hole pattern identical to that of the upper mask.

12. The laser welding method according to claim 10, wherein the through-holes of the upper mask are formed in a predetermined pattern, and
the lower mask includes a through-hole pattern different from that of the upper mask.

13. The laser welding method according to claim 12, wherein a horizontal sectional shape of the through-hole in the lower mask differs from that of the through-hole in the upper mask.

14. The laser welding method according to claim 12, wherein a horizontal sectional area of the through-hole in the lower mask differs from that of the through-hole in the upper mask.

15. The laser welding method according to claim 10, wherein the lower mask does not include through-holes.

16. The laser welding method according to claim 15, wherein the lower mask comprises a groove in a laser irradiation region on a surface facing the upper mask.

17. The laser welding method according to claim 10, wherein the lower mask further comprises a pressurizing device in a laser irradiation region on a surface facing the upper mask.

18. The laser welding method according to claim 17, wherein the pressurizing device comprises at least one selected from the group consisting of a spring, a cylinder and a servo cylinder.

19. The laser welding method according to claim 10, wherein the method does not include a pre-welding step.

20. A lithium secondary battery comprising electrode tabs and electrode leads welded using the laser welding method according to claim 10.
